(19) United States
(12) Patent Application Publication
(10) Pub. No.: US 2026/0329230 A1
(43) Pub. Date: Oct. 22, 2026

(54) POLARIZATION-SPLITTING DOUBLE-SCANNING HOLOGRAPHY SYSTEM FOR TRANSMISSION BODY

(71) Applicant: CUBIXEL CO.,LTD., Seoul (KR)

(72) Inventors: Taegeun KIM, Seoul (KR); Bongyon KIM, Seoul (KR); Sunpil LEE, Anyang-si, Gyeonggi-do (KR)

(73) Assignee: CUBIXEL CO.,LTD., Seoul (KR)

(21) Appl. No.: 19/114,786

(22) PCT Filed: Aug. 11, 2023
(86) PCT No.: PCT/KR2023/011950

§ 371 Date: Mar. 24, 2025

(30) Foreign Application Priority Data
Sep. 28, 2022 (KR) 10-2022-0123460

(51) Int. Cl. G03H 1/04

(52) U.S. Cl. CPC G03H 1/0443; G03H 2001/0458

(57) ABSTRACT

The present disclosure relates to a polarization-splitting double-scanning holography system. The system includes a scan beam generating unit configured to convert a first and a second beams split from a light source into a first and a second curvature beams, and generate a scan beam by interfering the first and second curvature beams, a scan beam splitting unit configured to split the scan beam into an s-polarized beam and a p-polarized beam and emit parallel to each other, a scan unit configured to project the scan beam onto a transmission body, and controls a scanning position of the scan beam for the transmission body, a light detection unit configured to detect separately the s-polarized beam and the p-polarized beam from a beam transmitting through the transmission body, and a signal processing unit configured to process signals of the detected beams to generate a hologram of the transmission body.

### TECHNICAL FIELD

The present disclosure relates to a polarization-splitting double-scanning holography system for a transmission body, and more particularly, to a polarization-splitting double-scanning holography system for a transmission body which may implement a scanning hologram for a transmission body that is a transmissive object at an ultra-high speed.

### BACKGROUND ART

The conventional optical scanning hologram system forms a beam pattern having a spatial distribution of a Fresnel zone plate by using an interferometer, and obtains a hologram of an object by projecting the formed beam pattern onto a target object and collecting and detecting the light reflected from or transmitted through the target object.

However, the conventional method has a problem in that the speed of obtaining a hologram depends on the scanning speed of a scan mirror.

Therefore, a new technique is required which may obtain a hologram of a target object faster than the scanning speed of the scan mirror.

The technology that becomes the background of the present disclosure is disclosed in Korean U.S. Pat. No. 1,304,695 (announced on Sep. 6, 2013).

### DISCLOSURE

### Technical Problem

An objective of the present disclosure is to provide a polarization-splitting double-scanning holography system for a transmission body which may implement a scanning hologram for a transmission body that is a transmissive object at an ultra-high speed.

### Technical Solution

The present disclosure provides a polarization-splitting double-scanning holography system for a transmission body including a scan beam generating unit configured to modulate a phase of a first beam split from a light source and convert the first beam into a first curvature beam through a first beam curvature generating unit, convert a second beam into a second curvature beam through a second beam curvature generating unit, and generate a scan beam by interfering the first curvature beam and the second curvature beam, a scan beam splitting unit configured to split the scan beam into an s-polarized beam and a p-polarized beam and emit the s-polarized beam and the p-polarized beam parallel to each other, a scan unit configured to receive the scan beam composed of the s-polarized beam and the p-polarized beam emitted parallel to each other from the scan beam splitting unit, project the scan beam onto a transmission body, and transfers the scan beam to the transmission body by controlling a scanning position of the scan beam for the transmission body in a horizontal direction and a vertical direction, a light detection unit configured to detect separately the s-polarized beam and the p-polarized beam from a beam transmitting through the transmission body, and a signal processing unit configured to process signals of the separately detected s-polarized beam and p-polarized beam to generate a hologram of the transmission body.

Also, the light detection unit may include a first condenser arranged in a direction polarized to an optical axis of a beam projected onto the transmission body and configured to condense a beam transmitting through the transmission body, a first polarizer configured to cause only an s-polarized beam component of a beam spatially condensed through the first condenser to transmit through the first polarizer, a first photodetector configured to detect an s-polarized beam transmitting through the first polarizer, a second condenser arranged in a direction polarized to the optical axis of the beam projected onto the transmission body, arranged at a different position from the first condenser, and configured to condense a beam transmitting through the transmission body, a second polarizer configured to cause only a p-polarized beam component of a beam spatially condensed through the second condenser to transmit through the second polarizer, and a second photodetector configured to detect a p-polarized beam transmitting through the second polarizer.

Also, the light detection unit may include a first light splitter arranged on an optical axis of light projected onto the transmission body, receive a beam transmitting through the transmission body, and reflect the beam to an external unit, a second light splitter configured to receives light reflected from the first light splitter, cause a p-polarized beam component to transmit through the second light splitter, and reflect a s-polarized beam component of an incident beam, a first condenser configured to condense the s-polarized beam component reflected from the second light splitter, a second condenser configured to condense the p-polarized beam component transmitting through the second light splitter, a first photodetector configured to detect a beam spatially condensed through the first condenser, and a second photodetector configured to detect a beam spatially condensed through the second condenser.

Also, the light detection unit may include a first light splitter arranged on an optical axis of light projected onto the transmission body, receive a beam transmitting through the transmission body, and reflect the beam to an external unit, a second light splitter configured to receive light reflected from the first light splitter, cause some of incident beams to transmit through the second light splitter, and reflect others of the incident beams, a first polarizer configured to receive a beam reflected from the second light splitter and cause only an s-polarized beam component to transmit through the first polarizer, a second polarizer configured to receive a beam transmitting through the second light splitter and cause only a p-polarized beam component to transmit through the second polarizer, a first condenser configured to condense the s-polarized beam component transmitting through the first polarizer, a second condenser configured to condense the p-polarized beam component transmitting through the second polarizer, a first photodetector configured to detect a beam spatially condensed through the first condenser, and a second photodetector configured to detect a beam spatially condensed through the second condenser.

Also, the signal processing unit may include a first signal processing unit configured to process a signal of the s-polarized beam detected by the first photodetector, a second signal processing unit configured to process a signal of the p-polarized beam detected by the second photodetector, and a cross-array signal processing unit configured to synthesize a hologram signal processed by the first signal processing unit and another hologram signal processed by the second signal processing unit in a cross-array manner to generate a hologram of the transmission body.

Also, the scan beam splitting unit may include a beam displacer made of an anisotropic optical material, and configured to split a scan beam incident through a first surface into an s-polarized beam and a p-polarized beam orthogonal to each other and emit the s-polarized beam and the p-polarized beam side by side through a second surface.

Also, the scan beam splitting unit may further include an optical path difference correction unit installed on a path of the p-polarized beam, which is shorter among paths of the s-polarized beam and the p-polarized beam emitted through the second surface, implemented with the same material as the beam displacer, and configured to compensate for a difference in optical path length between the s-polarized beam and the p-polarized beam which are emitted.

Also, the scan beam splitting unit may include a polarization prism made of a combination of two triangular prisms whose crystal axes are perpendicular to each other and made of different materials, and configured to split a scan beam incident through a first surface into a first polarized beam that travels parallel to the scan beam at a boundary between the two triangular prisms and a second polarized beam that travels at a set angle to the scan beam and emit the first polarized beam and the second polarized beam through a second surface, and when the first polarized beam is the s-polarized beam, the second polarized beam may be the p-polarized beam, and when the first polarized beam is the p-polarized beam, the second polarized beam may be the s-polarized beam.

Also, the scan beam splitting unit may further include a displacement adjustment unit configured to adjust a travel direction of travel of the second polarized beam to be parallel to the scan beam through a first mirror and a second mirror that are sequentially installed on a path of the second polarized beam emitted through a second surface and change a beam path, and an optical path difference correction unit installed on a path of the first polarized beam, which is shorter among paths of the first polarized beam and the second polarized beam emitted through the second surface, and configured to compensate for a difference in optical path length between the first polarized beam and the second polarized beam that are emitted.

Also, the optical path difference correction unit may include third to sixth mirrors sequentially installed on the path of the first polarized beam emitted through the second surface to change a beam path, and a mirror movement unit configured to move fourth and fifth mirrors separated from the third and sixth mirrors as a group and compensate for the difference in the optical path length.

Also, the polarization prism may have a Rochon prism structure or a Senarmont prism structure.

Also, the polarization prism may be installed in a state of being rotated by a set angle based on a center of a boundary surface, and the set angle may be θ/2 which is half of an angular difference θ between propagation directions of the first polarized beam and the second polarized beam separately emitted from the center of the boundary surface.

Also, the scan beam splitting unit may further include a displacement control unit including first and second mirrors that are sequentially installed on a path of the second polarized beam emitted through the second surface to change a beam path, and third and fourth mirrors that are sequentially installed on a path of the first polarized beam emitted through the second surface to change a beam path and are installed symmetrically to the first and second mirrors, and a propagation direction of the second polarized beam transmitting through the second mirror and a propagation direction of the first polarized beam transmitting through the fourth mirror may be adjusted to be parallel by the displacement control unit.

Also, the scan beam splitting unit may include a polarization prism that has a Wollaston prism structure, is formed by a combination of two triangular prisms having crystal axes perpendicular to each other and made of different materials, splits a scan beam incident through a first surface into an s-polarized beam and a p-polarized beam that travel symmetrically to a direction of the scan beam at a set angle at a boundary between two triangular prisms, and emits the s-polarized beam and the p-polarized beam through a second surface.

Also, the scan beam splitting unit may further include a displacement control unit including first and second mirrors that are sequentially installed on a path of the p-polarized beam emitted through the second surface to change a beam path, and third and fourth mirrors that are sequentially installed on a path of the s-polarized beam emitted through the second surface to change a beam path and are installed symmetrically to the first and second mirrors, and a propagation direction of the p-polarized beam transmitting through the second mirror and a propagation direction of the s-polarized beam transmitting through the fourth mirror may be adjusted to be parallel by the displacement control unit.

Also, the scan beam splitting unit may include a first polarization beam splitting unit configured to reflect an s-polarized beam component of an incident scan beam and transmit a p-polarized beam component through the first polarization beam splitting unit, first and second mirrors sequentially installed on a path of the s-polarized beam reflected by the first polarization beam splitting unit to change a beam path by 90 degrees, third to sixth mirrors sequentially installed on a path of the p-polarized beam transmitting through the first polarization beam splitting unit to change a beam path by 90 degrees, and a second polarization beam splitter configured to receive an s-polarized beam transmitting through the second mirror and a p-polarized beam transmitting through the sixth mirror respectively through a first surface and a second surface, and emit an s-polarized beam reflected after being incident on the first surface and a p-polarized beam transmitted after being incident on the second surface in a parallel direction through a third surface.

Also, the scan unit may include a horizontal scan mirror and a vertical scan mirror to control a scan position of the scan beam for a transmission body, and controls the incident scan beam in the horizontal direction and the vertical direction and transfers the scan beam to the transmission body.

Also, the scan unit may include a scan mirror for controlling the scan beam incident from the scan beam splitter in the horizontal direction and transfers the scan beam to a transmission body and a translation stage for moving the transmission body in the vertical direction at a rear end of the transmission body, in order to control a scan position of the scan beam for the transmission body in the horizontal direction and the vertical direction.

Also, the scan unit may include a spatial modulation scanner for controlling the scan beam incident from the scan beam splitter in the horizontal direction and transfers the scan beam to a transmission body, and a translation stage for moving the transmission body in the vertical direction at a rear end of the transmission body, in order to control a scan position of the scan beam for the transmission body in the horizontal direction and the vertical direction.

Also, the scan unit may include a vertical scanner and a horizontal scanner for controlling a scan position of the scan beam for a transmission body in the horizontal direction and the vertical direction, a horizontal spatial modulation scanner for controlling the scan beam incident from the scan beam splitting unit in the horizontal direction and transfers the scan beam to the transmission body, and a vertical spatial modulation scanner for controlling the scan beam in the vertical direction and transfers the scan beam to the transmission body.

### Advantageous Effects

According to the present disclosure, a hologram of a transmission body that is a transmissive object may be obtained at an ultra-high speed faster than a scanning speed of a scan mirror.

### DESCRIPTION OF DRAWINGS

FIG. 1 is a diagram illustrating a configuration of a polarization-splitting double-scanning holography system for a transmission body, according to a first embodiment of the present disclosure.

FIG. 2A is a diagram illustrating a configuration of a polarization-splitting double-scanning holography system for a transmission body, according to a second embodiment of the present disclosure.

FIG. 2B is a diagram illustrating a modified example of FIG. 2A.

FIG. 3 is a diagram illustrating a configuration of a polarization-splitting double-scanning holography system for a transmission body, according to a third embodiment of the present disclosure.

FIG. 4A is a diagram illustrating a configuration of a polarization-splitting double-scanning holography system for a transmission body, according to a fourth embodiment of the present disclosure.

FIG. 4B is a diagram illustrating a modified example of FIG. 4A.

FIG. 5A to FIG. 5H are diagram illustrating various embodiments of a scan beam splitting unit illustrated in FIG. 1.

FIG. 6 is a diagram illustrating an operation of a signal processing unit according to an embodiment of the present disclosure.

FIG. 7 is a diagram illustrating an operating principle of a spatial modulation scanner.

FIG. 8 is a diagram illustrating an operating principle of a horizontal and vertical spatial modulation scanner.

### BEST MODE FOR CARRYING OUT INVENTION

Then, embodiments of the present disclosure will be described in detail with reference to the attached drawings such that those skilled in the art may easily implement the present disclosure. However, the present disclosure may be implemented in various different forms and is not limited to the embodiments described herein. In addition, in order to clearly describe the present disclosure with reference to the drawings, parts that are not related to the description are omitted, and similar parts are given similar reference numerals throughout the specification.

Throughout the specification, when a portion is described to be “connected” to another portion, this includes not only a case where the portion is “directly connected” but also a case where the portion is “electrically connected” with another element therebetween. Also, when a part is said to “include” a certain component, this does not mean that other components are excluded, but rather that other components may be further included, unless otherwise specifically stated.

The present disclosure relates to a polarization-splitting double-scanning holography system for a transmission body, and proposes a polarization-splitting double-scanning holography system for rapidly obtaining a hologram for a transmissive object (hereinafter, a transmission body).

The present disclosure proposes an optical system structure in which a beam generated by a scan beam generating unit is split into an s-polarized beam and a p-polarized beam, and then projected in parallel onto a transmission body that is a target object to be scanned, and the light transmitting through the transmission body is condensed and transferred to a light detection unit, and then the s-polarized beam and the p-polarized beam separated and detected by the light detection unit are processed, and thereby, a hologram for the transmission body is implemented at a high speed.

Hereinafter, a polarization-splitting double-scanning holography system for a transmission body, according to an embodiment of the present disclosure is described in more detail with reference to drawings.

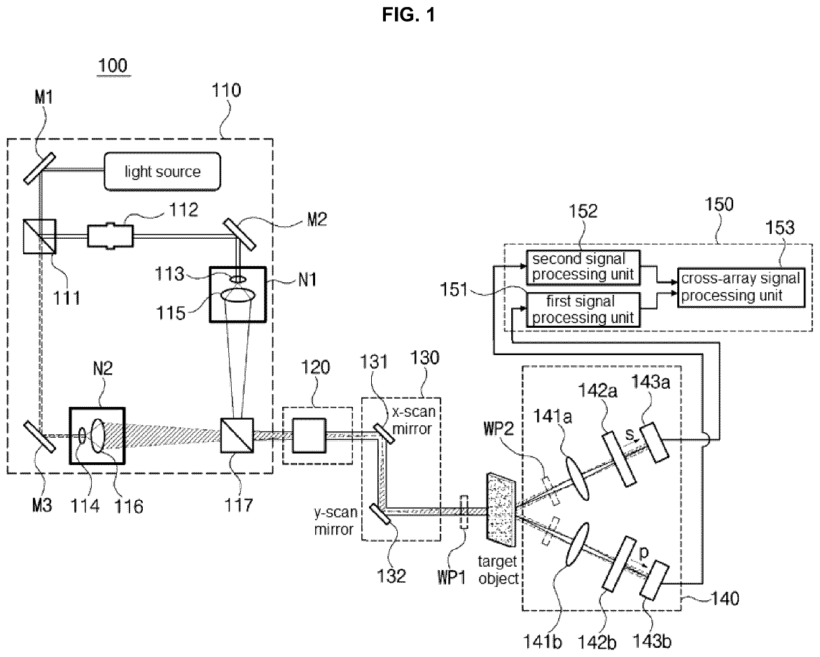

FIG. 1 to FIG. 4 are diagrams illustrating configurations of polarization-splitting double-scanning holography systems for a transmission body, according to the first to fourth embodiments of the present disclosure.

First, as illustrated in FIG. 1, a polarization-splitting double-scanning holography system 100 for transmission body, according to the first embodiment of the present disclosure, includes a scan beam generation unit 110, a scan beam splitting unit 120, a scan unit 130, a light detection unit 140, and a signal processing unit 150. The basic structure is also applied to the second to fourth embodiments.

First, the scan beam generation unit 110 converts a first beam among first and second beams, which is split from a light source, into a first curvature beam by frequency-shifting the first beam through a first lens 115, converts the second beam into a second curvature beam through a second lens 116, and then interferes the first curvature beam and the second curvature beam to form a scan beam.

The scan beam generation unit 110 uses a Mark-Zehnder interferometer structure that splits the light emitted from the light source into the first and second beams, generates the first and second curvature beams, and then recombines the two generated beams.

The scan beam generation unit 110 includes a first mirror M1, a light splitter 111, a frequency shifting unit 112, second and third mirrors M2 and M3, first and second beam curvature generation units N1 and N2, and an interference unit 117, and may further include a light source.

The light source generates electromagnetic waves. The light source may include various units, such as a laser generator capable of generating electromagnetic waves, an LED (light emitting diode), a beam with low coherence such as a halogen light with a short coherence length, and so on. Hereinafter, a light source implemented with a laser generator is provided as a representative example.

A beam output from the light source is transferred to the first mirror M1 and then reflected and incident on the light splitter 111.

The light splitter 111 splits the incident beam into a first beam and a second beam, transfers the first beam to a phase modulation unit 112 (an acoustic-optical modulator) and transfers the second beam to a third mirror M3. That is, the beam following a path of the first beam in the optical splitter 111 is transferred to the phase modulation unit 112, and the beam following a path of the second beam is transferred to a third mirror M3.

Here, the optical splitter 111 may be composed of an optical fiber coupler, a beam splitter, a geometric phase lens, and so on, and may transfer the beam to the outside by propagating through a free space. Here, when a unit capable of splitting the beam in-line, such as a geometric phase lens, is used, a beam may be split into the first beam and the second beam in-line. Hereinafter, it is assumed that each optical splitter is implemented with a beam splitter.

The phase modulation unit 112 shifts the frequency of the first beam and transfers the first beam to the second mirror M2. The frequency shifting unit, that is, a phase modulation unit, may shift the frequency of the first beam by Q by using a frequency generated from a function generator (not illustrated) and transfer the frequency-shifted first beam to the second mirror M2. Here, the phase modulation unit may be implemented with various types of modulators that modulate a phase of light according to an electrical signal including an acousto-optic modulator and an electro-optic modulator.

The first beam reflected from the second mirror M2 is transferred to the first beam curvature generator N1. The second beam reflected from the third mirror M3 is transferred to the second beam curvature generator N2. A beam expander may be implemented with a collimator.

The first and second beam curvature generation units N1 and N2 respectively receive beams and generate expanded beams each having a curvature between negative and positive curvatures, including a collimated beam.

A specific implementation example of the first beam curvature generation unit N1 is a beam expander including a first lens 113 that converts the first beam reflected from the second mirror M2 into a spherical wave and a second lens 115 that receives a spherical wave and generates a beam having a curvature (a first curvature beam), and may adjust a curvature of the beam by adjusting a distance between the first lens 113 and the second lens 115. A specific implementation example of the second beam curvature generation unit N2 is a beam expander including a third lens 114 that converts the second beam reflected from the third mirror M3 into a spherical wave and a fourth lens 116 that receives a spherical wave and generates a beam having a curvature (a second curvature beam), and may adjust a curvature of the beam by adjusting a distance between the third lens 114 and the fourth lens 116.

The first beam curvature generation unit N1 converts the first beam into a first curvature beam and transfers the first curvature beam to an interference unit 117. That is, the first beam curvature generation unit N1 modulates a spatial distribution of the first beam to generate the first curvature beam.

The second beam curvature generation unit N2 converts the second beam into the second curvature beam and transfers the second curvature beam to the interference unit 117. That is, The second beam curvature generation unit N2 modulates a spatial distribution of the second beam to generate the second curvature beam.

The generated first and second curvature beams interfere with each other while transmitting through the interference unit 117 and are transferred to the scan unit 130. The interference unit 117 may be implemented with a beam splitter.

The interference unit 117 overlaps and interferes the first beam (first curvature beam) transmitting through the first beam curvature generation unit N1 and the second beam (second curvature beam) transmitting through the second beam curvature generation unit N2 to form a scan beam having an interference pattern of a Fresnel zone pattern. The Fresnel zone pattern may represent a beam pattern generated by the interference of the first curvature beam and the second curvature beam, which have different curvatures.

In this way, the scan beam generation unit 110 converts the first beam and the second beam separated from a light source into the first and second curvature beams, and then overlaps the first and second curvature beams with each other through the interference unit 117 to form a scan beam, and transfers the formed scan beam to the scan beam splitting unit 120.

Here, it is preferable that the scan beam generated by the scan beam generation unit 110 is a beam that is linearly polarized at 45 degrees with respect to a horizontal direction of the scan beam splitting unit 120 (a direction in which the beam is incident on the scan beam splitting unit in FIG. 1) or is not linearly polarized.

To this end, a beam, which is linearly polarized at 45 degrees with respect to the horizontal direction of the scan beam splitting unit 120, may be generated from a laser, or a beam polarized at 45 degrees with respect to the horizontal direction of the scan beam splitting unit 120 may be generated by outputting a linearly polarized beam in a certain direction from a laser and rotating the linearly polarized direction of the output laser beam by using a wave plate. When a circularly polarized beam is generated from a laser beam, it is also possible to change the circularly polarized beam into a linearly polarized beam by using a wave plate.

The scan beam splitting unit 120 splits an incident scan beam into an s-polarized beam and a p-polarized beam and emits the two polarized beams in parallel toward the scan unit 130. That is, the scan beam splitting unit 120 splits the scan beam received from the scan beam generation unit 110 into two scan beams (the first scan beam: an s-polarized beam, the second scan beam: p-polarized beam) according to polarization and then emits the two scan beams in parallel and transfers the two scan beams to the scan unit 130.

This scan beam splitting unit 120 may include a function of splitting a scan beam into an s-polarized beam and a p-polarized beam, a function of adjusting an optical path length between the two split beams to be the same, and a function of making a traveling direction of the two split beams in parallel.

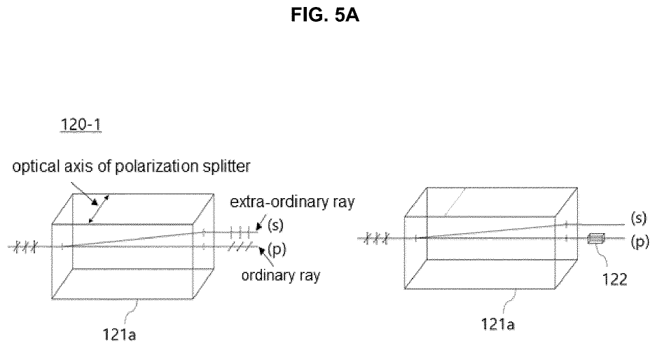

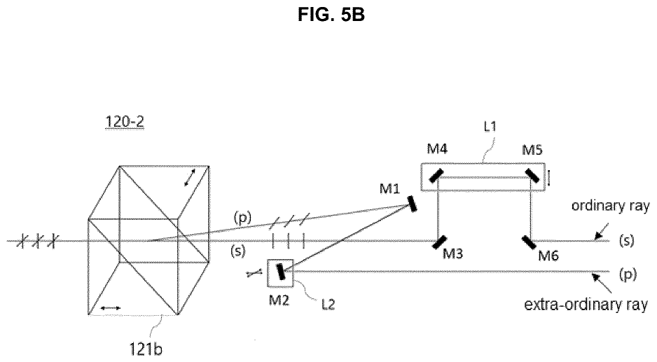

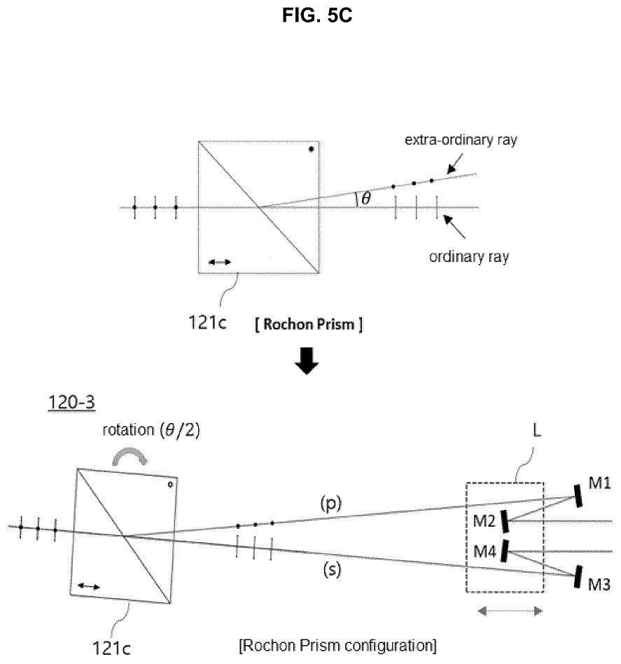

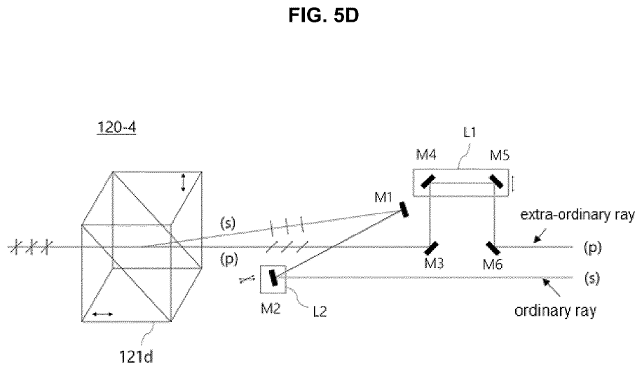

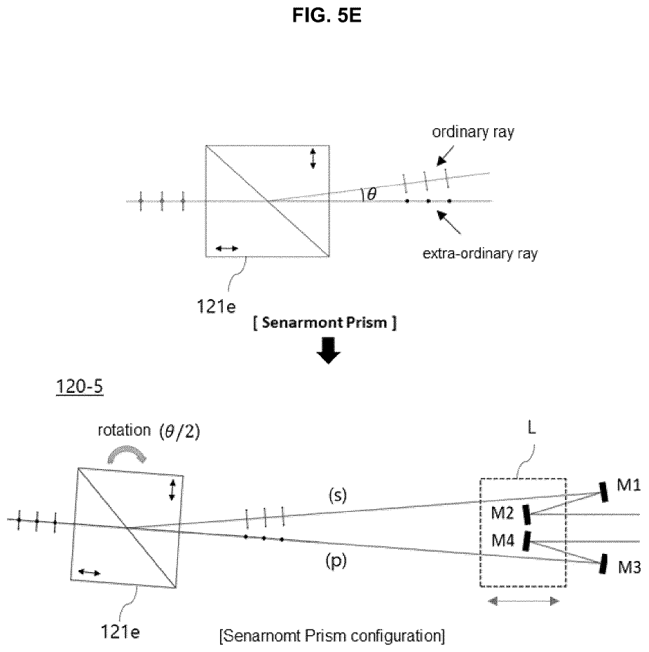

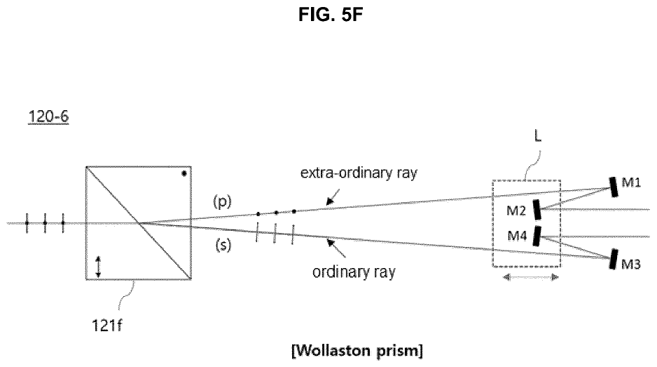

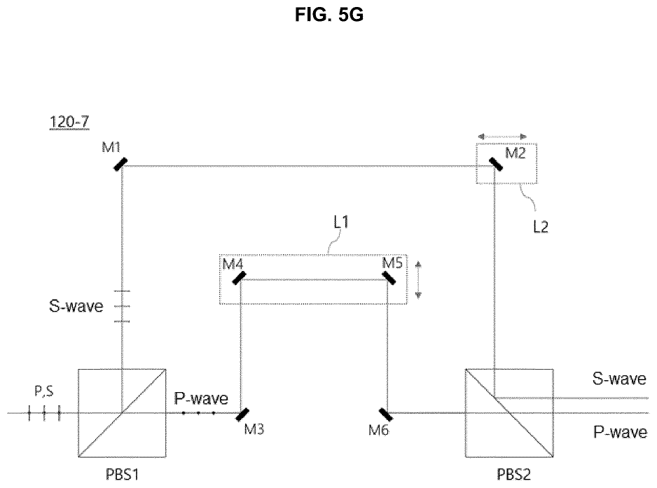

The first function may be implemented through a beam displacer, a polarization prism, or a polarized beam splitter (PBS), and the second and third functions may be implemented with a combination of multiple mirrors or a combination of multiple mirrors and a polarized beam splitter (PBS). This is described in detail with reference to FIGS. 5A and 5b below.

Subsequently, a configuration of the scan beam splitting unit illustrated in FIG. 1 is described in more detail. The scan beam splitting unit 120 may be implemented to have various structures as follows.

FIG. 5A to FIG. 5H are diagrams illustrating various embodiments of the scan beam splitting unit illustrated in FIG. 1.

First, FIG. 5A is a first embodiment of the scan beam splitting unit, and a scan beam splitting unit 120-1 includes a beam displacer 121a corresponding to a polarization splitter, and may further include an optical path difference correction unit 122 that corrects an optical path difference between two polarized beams split as illustrated in the right figure of FIG. 5A.

The beam displacer 121a splits a scan beam that is incident through a first surface into an s-polarized beam and a p-polarized beam orthogonal to each other, and emits the s-polarized beam and p-polarized beam side by side through a second surface. In this case, the beam displacer 121a is made of an anisotropic optical material, and calcite, YVO4, α-BBO, TeO2, and so on may be used as the anisotropic optical material.

In FIG. 5A, among emitted two polarized beams, a ray whose polarization vibrates in the same direction as an optical axis (see an optical axis mark on an upper surface) of the beam displayer 121a is referred to as an ordinary ray, and a ray whose polarization vibrates in a direction perpendicular to the optical axis is referred to as an extra-ordinary ray.

In FIG. 5A, the p-polarized beam emitted from the beam displacer 121a corresponds to the ordinary ray parallel to the optical axis of the beam displacer 121a, and the s-polarized beam corresponds to an extra-ordinary ray perpendicular to the optical axis.

In this way, when the beam displacer 121a is implemented with an optical material whose crystal structure is anisotropic, the beam displacer 121a has a birefringence characteristic in which a refractive index changes depending on polarizations, and accordingly, a 45-degree polarized or unpolarized beam may be incident and split into two linearly polarized beams (an s-polarized beam and a p-polarized beam) with a 90-degree phase difference.

Therefore, in FIG. 5A, by using a polarization splitter made of only anisotropic optical material, two beams, the s-polarized beam and the p-polarized beam, whose polarization states are perpendicular to each other with respect to a plane including an optical axis, may be emitted in a direction parallel to an incident beam.

Here, a difference in optical path occurs between the two polarized beams emitted separately from the beam displacer 121a, and the optical path difference correction unit 122 may be used to correct the difference. In this case, an optical material with the same conditions as the beam displacer 121a may be installed at a position where the ordinary ray is emitted, and the difference in optical path between the two beams may be corrected by using the optical material.

Specifically, the optical path difference correction unit 122 is installed on a path of the p-polarized beam, which is shorter than paths of the s-polarized beam and the p-polarized beam that are emitted through a second surface of the beam displacer 121a, and may be implemented with the same optical material as the beam displacer 121a to compensate for a difference in optical path length between the s-polarized beam and the p-polarized beam that are emitted.

Here, by adjusting a thickness of the optical material (light material) that constitutes the beam displacer 121a, exit positions (an inter-beam spacing) of the s-polarized beam and the p-polarized beam may be adjusted, and through this, a displacement value of the emitted beam through the beam displacer 121a may be adjusted.

Next, FIG. 5B is a second embodiment of the scan beam splitting unit, and a scan beam splitting unit 120-2 illustrated in FIG. 5B includes a polarization prism 121b having a Rochon prism structure, and may further include a displacement adjusting unit and an optical path difference correction unit using multiple mirrors.

The polarization prism 121b illustrated in FIG. 5B is implemented with a Rochon prism, and is made by a combination of two triangular prisms whose crystal axes are perpendicular to each other and made of different materials. Here, the polarization prism 121b splits a scan beam that is incident through a first surface into an s-polarized beam that travels in parallel to the scan beam (incident light) at a boundary between the two triangular prisms, and a p-polarized beam that travels at a set angle with respect to the scan beam (incident light), and then emits the beams through a second surface.

In FIG. 5B, a crystal axis of the first triangular prism that meets the incident light is a short-axis crystal and is in the same direction as the incident light, and a crystal axis of the second triangular prism is perpendicular within a crystal axis plane of the first prism. Here, the incident light is split into an extra-ordinary ray that is emitted at an angle and an ordinary ray that is emitted parallel to the incident light at a boundary between the two triangular prism materials, according to a wavelength of the light and a refractive index of a material.

In FIG. 5B, the s-polarized beam that is emitted parallel to the incident beam corresponds to the ordinary ray, and the p-polarized beam that is emitted at an angle to the incident beam corresponds to the extra-ordinary ray.

Referring to FIG. 5B, the displacement control unit includes a plurality of mirrors, and specifically, first and second mirrors M1 and M2. Here, the displacement control unit may further include a position adjustment unit L2 that controls a position of the second mirror M2 at the rear end of the two mirrors.

The first and second mirrors M1 and M2 are sequentially installed on a path of the p-polarized beam emitted through a second surface of the polarization prism 121b and adjust a propagation direction of the p-polarized beam to be parallel to the scan beam by changing the beam path. That is, the p-polarized beam transmitting through the last second mirror M2 becomes parallel to the scan beam. In addition, when a position of the second mirror M2 is adjusted by the position adjustment unit L, a position of the p-polarized beam with respect to the s-polarized beam may be adjusted.

In this way, the displacement adjustment unit may cause extra-ordinary ray to be parallel to ordinary ray through the two mirrors M1 and M2 and adjust a displacement of a beam by adjusting the second mirror M2 through the position adjustment unit L2.

Also, the present disclosure is not limited to the description given above, and positions or displacement values of the two beams emitted from the polarization prism 121b may be adjusted according to an arrangement and angles of a plurality of mirrors M1 to M6 included in FIG. 5B.

Here, because the ordinary ray (the s-polarized beam in FIG. 5B) that travels parallel to the incident light has a shorter optical path than the extra-ordinary ray (the p-polarized beam in FIG. 5B), optical path lengths are corrected to be equal to each other by an optical path difference correction unit.

The optical path difference correction unit is installed on a path of the s-polarized beam among paths of the s-polarized beam and the p-polarized beam emitted through a second surface of the polarization prism 121b, and compensates for a difference in optical path length between the s-polarized beam and the p-polarized beam that are emitted, and for this purpose, the third to sixth mirrors M3 to M6 and a mirror movement unit L1 may be included.

The third to sixth mirrors M3 to M6 may be sequentially installed on a path of the s-polarized beam emitted through the second face of the polarization prism 121b to change the beam path, and specifically, may be sequentially installed in a ‘⊏’ shape on a path of the s-polarized beam to change the beam path of the s-polarized beam by 90 degrees.

Through this, the s-polarized beam transmitting through the last sixth mirror M6 becomes parallel to the incident beam. In addition, the p-polarized beam separated by the polarization prism 121b is parallel to the incident beam through an operation of the displacement control unit including the first and second mirrors M1 and M2 described above, and accordingly, the p-polarized beam and the s-polarized beam are finally parallel to each other.

Also, the mirror movement unit L1 may adjust an optical path length of the s-polarized beam to be equal to an optical path length of the p-polarized beam by moving the fourth mirror M4 and the fifth mirror M5 that are arranged parallel to the third mirror M3 and the sixth mirror M6 as a group. In FIG. 5B, the optical path length of the s-polarized beam may be increased or decreased by adjusting the mirror movement unit L1 up and down.

Next, FIG. 5C is a third embodiment of the scan beam splitting unit, and a scan beam splitting unit 120-3 illustrated in FIG. 5C includes a polarization prism 121c having a Rochon prism structure and may further include a displacement control unit.

The polarization prism 121c illustrated in FIG. 5C is implemented with a Rochon prism and is made by a combination of two triangular prisms whose crystal axes are perpendicular to each other and made of different materials.

As in FIG. 5B, a scan beam that is incident through a first surface of the polarization prism 121c is split into an s-polarized beam that travels parallel to the scan beam at a boundary between two triangular prisms and a p-polarized beam that travels at a set angle with the scan beam, and the two beams are emitted through the second surface.

In this case, a difference from FIG. 5B is that, as illustrated in a lower figure of FIG. 5C, the polarization prism 121c is installed (arranged) in a state of being rotated by a set angle θ/2 with respect to the center of a boundary between the two triangular prisms. In this case, θ corresponds to an angular difference between travel directions of the s-polarized beam and the p-polarized beam that are separated and emitted from the center of the boundary as illustrated in an upper figure of FIG. 5C.

That is, as illustrated in the lower figure of FIG. 5C, the polarization prism 121c is arranged in a state of being rotated by θ/2, which corresponds to half of the angular difference θ between the polarized beams. In this case, unlike FIG. 5B, only a displacement control unit is required, and an optical path difference correction unit is unnecessary, and accordingly, the scan beam splitting unit 120-3 may be implemented to have a simpler structure.

In the third embodiment, the displacement control unit includes first and second mirrors M1 and M2 that are sequentially installed on a path of the p-polarized beam emitted through a second face of the polarization prism 121c to change a beam path, and third and fourth mirrors M3 and M4 that are sequentially installed on a path of the s-polarized beam emitted through the second face to change a beam path and are installed symmetrically to the first and second mirrors M1 and M2. In this way, a propagation direction of the p-polarized beam transmitting through the second mirror M2 and a propagation direction of the s-polarized beam transmitting through the fourth mirror M4 are adjusted to be parallel by the displacement control unit.

In addition, the displacement control unit may further include a position control unit L that moves and controls positions of the second mirror M2 and the fourth mirror M4 as a group.

In this way, the displacement control unit may cause an extra-ordinary ray (the p-polarized beam) to be parallel to the incident light through the first and second mirrors M1 and M2 and cause an ordinary ray (the s-polarized beam) to be parallel to the incident light through the third and fourth mirrors M3 and M4, and may additionally adjust displacement values of the beams by moving positions of the second mirror M2 and the fourth mirror M4 as a group through the position control unit L.

As a result, in FIG. 5B, six mirrors are used to cause the extra-ordinary ray emitted from the polarization prism at an angle to be parallel to the incident light, but in FIG. 5C, the same effect may be achieved by simply using four mirrors based on a rotation structure of the polarization prism.

Next, FIG. 5D is a fourth embodiment of the scan beam splitting unit, and the scan beam splitting unit 120-4 illustrated in FIG. 5D includes a polarization prism 121d having a Senarmont prism structure, and may further include a displacement control unit and an optical path difference correction unit.

The polarization prism 121d illustrated in FIG. 5D is implemented with a Senarmont prism, and is made by a combination of two triangular prisms whose crystal axes are perpendicular to each other and made of different materials.

Here, the polarization prism 121d splits a scan beam that is incident through a first surface into a p-polarized beam that travels parallel to the scan beam at a boundary between two triangular prisms, and an s-polarized beam that travels at a set angle to the scan beam, and emits the two polarized beams through a second surface.

In this FIG. 5D, a crystal axis of the second triangular prism is perpendicular to a crystal axis of the first triangular prism. In this case, it may be seen that the crystal axis of the second triangular prism has a different vertical direction from the crystal axis of the second triangular prism of FIG. 5B. Here, the incident light is split into an ordinary ray that is emitted at an angle according to a wavelength of light and a refractive index of a material at a boundary between two triangular prism materials, and an extra-ordinary ray that is emitted parallel to the incident light.

In FIG. 5D, the p-polarized beam emitted parallel to the incident beam corresponds to an extra-ordinary ray, and the s-polarized beam that travels at an angle to the incident beam corresponds to an ordinary ray.

In FIG. 5D, a configuration of the displacement control unit including M1, M2, and L2, and a configuration of the optical path difference correction unit including M3 to M6 and L1 may each have the same structure and operating principle as the configuration illustrated in FIG. 5B, and accordingly, redundant descriptions related thereto are omitted.

Next, FIG. 5E is a fifth embodiment of the scan beam splitting unit, and a scan beam splitting unit 120-5 illustrated in FIG. 5E includes a polarization prism 121e having a Senarmont prism structure, and may further include a configuration of a displacement control unit including M1 to M4 and L as in FIG. 5C.

FIG. 5E simplifies the entire structure of the scan beam splitting unit as in FIG. 5C by rotating the polarization prism illustrated in FIG. 5D by θ/2. In FIG. 5E, a basic structure and an operating principle of the scan beam splitting unit are the same as in FIG. 5C, except that the scan beam splitting unit is implemented with a Senarmont prism, and accordingly, redundant descriptions thereof are omitted.

Next, FIG. 5F is a sixth embodiment of the scan beam splitting unit, and a scan beam splitting unit 120-6 illustrated in FIG. 5F includes a polarization prism 121f having a Wollaston prism structure, and may further include a displacement control unit including M1 to M4 and L as in FIG. 5C.

The polarization prism 121f is made by a combination of two triangular prisms whose crystal axes are perpendicular to each other and made of different materials, and splits a scan beam that is incident through a first surface into an s-polarized beam and a p-polarized beam that travel symmetrically to a direction of the scan beam at a set angle at a boundary between the two triangular prisms and are then emitted through a second surface.

In the Wollaston prism structure, when the crystal axis of the first triangular prism that meets the incident light is perpendicular to a travel direction of the incident light and the crystal axis of the second triangular prism is perpendicular to the first triangular prism, the incident light is split into an ordinary ray and an extra-ordinary ray that are emitted at an angle according to a wavelength of light and a refractive index of a material at a boundary between two materials.

Unlike FIG. 5C or FIG. 5E, a structure of FIG. 5F has an advantage of not requiring separate rotation of a polarization prism. In addition, in the embodiment of FIG. 5F, the displacement control unit including M1 to M4 and L has the same basic structure and operating principle as in FIG. 5C described above, and accordingly, detailed descriptions thereof are omitted. The displacement control unit may also adjust displacement values of two beams by moving M2 and M4 as a group at the same time.

Finally, FIG. 5G is a seventh embodiment of the scan beam splitting unit, and a scan beam splitting unit 120-7 illustrated in FIG. 5G includes first and second polarizing beam splitting units PBS1 and PBS2 and first to sixth mirrors M1 to M6. Here, a scan beam splitting unit 120g may further include a mirror movement unit L1 and a position adjustment unit L2.

The first polarization beam splitting unit PBS1 reflects an s-polarized beam component from an incident scan beam and transmits a p-polarized beam component therethrough. The first and second mirrors M1 and M2 are sequentially installed on a path of the s-polarized beam reflected by the first polarization beam splitting unit PBS1 and change the beam path by 90 degrees.

The third to sixth mirrors M3 to M6 are sequentially installed in a ‘⊏’ shape on a path of the p-polarized beam transmitted through the first polarization beam splitting unit PBS1 to change the beam path by 90 degrees.

The second polarization beam splitting unit PBS2 receives the s-polarized beam reflected by the first mirror M1 and the second mirror M2 and the p-polarized beam reflected by the third to sixth mirrors M3 to M6 respectively through the first and second surfaces.

The second polarization beam splitting unit PBS2 reflects the s-polarized beam that is incident on a first surface and transmits the p-polarized beam that is incident on a second surface therethrough, and accordingly, the reflected s-polarized beam and the transmitted p-polarized beam are emitted in parallel directions through a third surface. Also, the s-polarized beam and the p-polarized beam emitted in this way have directions parallel to the incident light.

In this case, the mirror movement unit L1 moves up and down the fourth mirror M4 and the fifth mirror M5 arranged side by side with the third mirror M3 and the sixth mirror M6 as a group, and accordingly, an optical path length of the p-polarized beam may be adjusted to be equal to an optical path length of the s-polarized beam.

In addition, the position adjustment unit L2 may adjust a displacement of the s-polarized beam emitted through the second polarization beam splitting unit PB2 by adjusting a position of the second mirror M2 left and right.

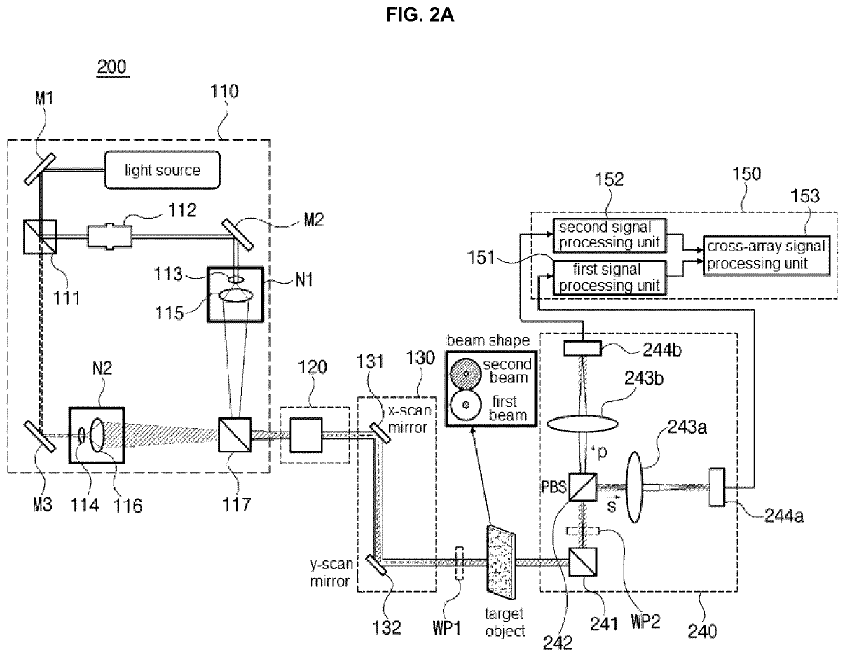

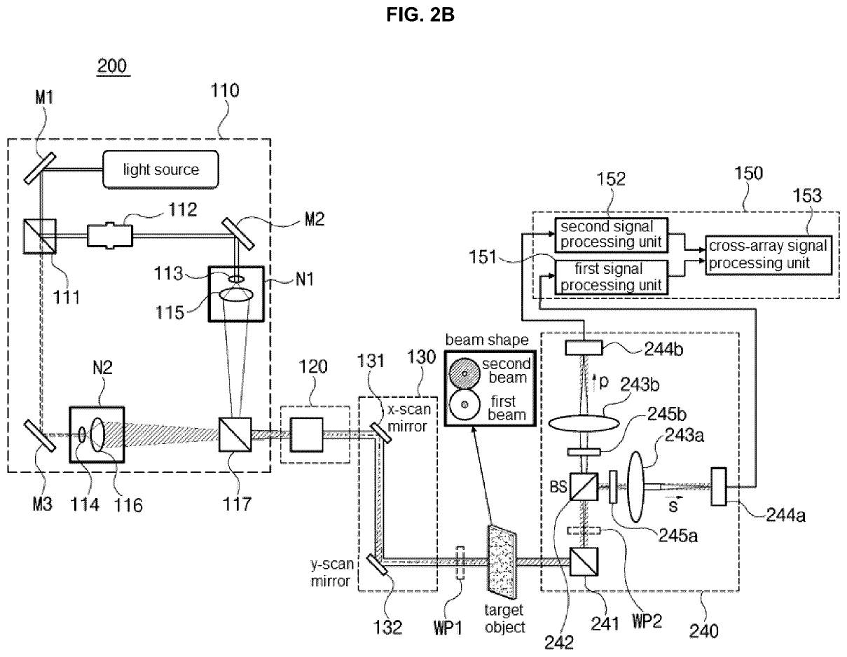

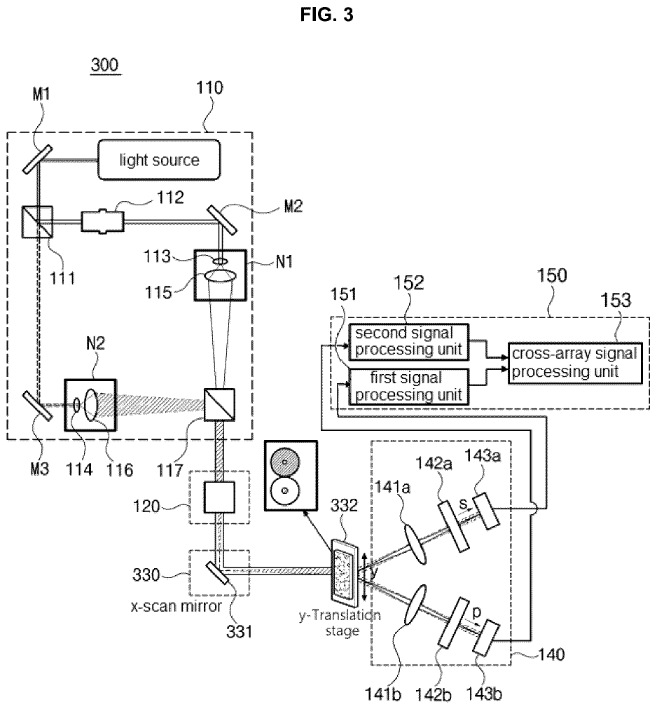

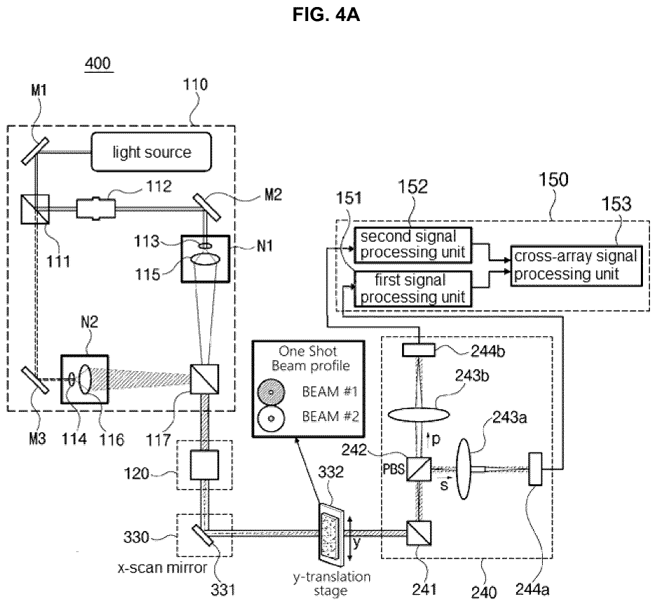

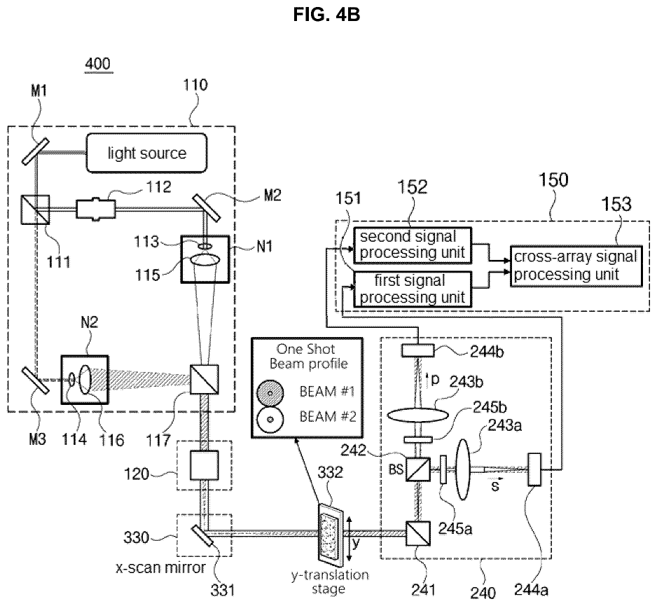

The various structures of the scan beam splitting unit (120; 120-1, 120-2, 120-3, 120-4, 120-5, 120-6, and 120-7) illustrated in FIG. 5A to FIG. 5G are all applicable to the first to fourth embodiments (FIG. 1, FIG. 2, FIG. 3, and FIG. 4) of the present disclosure.

Referring again to FIG. 1, two polarized beams (the s-polarized beam and the p-polarized beam) emitted parallel by the scan beam splitting unit 120 are transferred to the scan unit 130.

A beam incident on the scan unit 130 passes through a horizontal scan mirror 131 (hereinafter, an x-scan mirror) and a vertical scan mirror 132 (hereinafter, a y-scan mirror) and is transferred to a transmission body that is a transmissive object.

In this case, the transmission body may correspond to various objects having transmittance, such as a cell, a microorganism, a membrane, a transparent object, and a structure.

Here, the scan unit 130 includes an x-scan mirror 131 and a y-scan mirror 132 to control a scanning position of a scan beam with respect to a transmission body. The scan unit 130 controls the incident scan beam in a horizontal direction (the x direction) and a vertical direction (the y direction) by using the scan mirrors and transfers the scan beam to a transmission body.

That is, the scan unit 130 receives a scan beam composed of two polarized beams that are emitted parallel to each other from the scan beam splitting unit 120 and projects the scan beam onto a transmission body, while controlling a scan position of the scan beam with respect to the transmission body in the horizontal and vertical directions and transferring the scan beam to the transmission body.

In the first embodiment of FIG. 1, the scan unit 130 uses a mirror scanner. The mirror scanner is composed of an x-y scanner having an x-scan mirror 131 that scans an object (transmission body) in the x direction (left and right direction) with respect to the y-axis and a y-scan mirror 132 that scans an object (transmission body) in the y direction (up and down direction) with respect to the x-axis. Also, in the present disclosure, the scan unit is not limited to the mirror scanner, and a similar unit or other known scan unit may be used. For example, instead of the x-scan mirror and the y-scan mirror, the scanner may be replaced with an x-spatial modulation scanner and a y-spatial modulation scanner.

The scan unit 130 may operate by receiving a scan control signal from a scan control unit (not illustrated) of the signal processing unit 150. The scan control unit (not illustrated) may generate a scan control signal for controlling a scan position of the scan unit 130. Here, the scan control signal may include a horizontal scan signal and a vertical scan signal for respectively controlling the x-scan mirror and the y-scan mirror in the horizontal direction and the vertical direction.

In this case, the horizontal scan signal is a signal for sequentially moving the scan position by a preset distance unit with respect to the horizontal direction (the x-axis direction) and has a cycle T for a scan movement of a certain distance unit. The vertical scan signal is a control signal that enables a horizontal scan operation for the next y position when the horizontal scan operation in the x-axis direction for a certain y position is completed, and a cycle thereof is greater than a cycle of the horizontal scan signal.

In response to the control signal, optical axes of the first curvature beam and the second curvature beam are rotated according to the rotation of a scan mirror, and a scan beam pattern whose optical axis is rotated is projected onto an object (transmission body). In this way, the scan unit 130 may project an interference beam (a scan beam by the scan unit) between the first and second curvature beams onto a transmission body by using the scan mirror. Also, an s-wave component and a p-wave component for each curvature beam may have a structure separated vertically by the previous scan beam splitting unit 120, and the interference beam may also have a structure separated vertically between the two polarizations.

Also, the scan unit 130 may have a scan unit structure utilizing a horizontal scan mirror 331 and a translation stage 332 illustrated in FIG. 3, which will be described below, in addition to the horizontal scan mirror 131 and the vertical scan mirror 132 illustrated in FIG. 1. In addition, when the horizontal scan mirror 331 is replaced with a spatial modulation scanner, the structure of FIG. 3 may be changed to the scan unit structure that utilizes the spatial modulation scanner and the translation stage 332. In addition, the structure of FIG. 1 may be replaced with a horizontal spatial modulation scanner and a vertical spatial modulation scanner instead of the horizontal scan mirror 131 and the vertical scan mirror 132.

In this way, the scan unit 130 may be implemented with a combination of a horizontal scan mirror and a vertical scan mirror, a combination of a horizontal scan mirror and a translation stage, or a combination of a spatial light modulator and a translation stage. Other embodiments of the scan unit are described in detail below with reference to FIG. 3. Here, a table portion on which a target object (object) of the translation stage is placed can be made of a transparent material through which the wavelength of a laser light source transmits, or can be made of a free space.

A scan beam emitted to a transmission body by the scan unit 130 transmits through the transmission body and is incident on the light detection unit 140. As described above, a scan beam is composed of two polarized beams (an s-polarized beam and a p-polarized beam) split by the scan beam splitting unit 120.

The light detection unit 140 separates and detects the s-polarized beam and the p-polarized beam from a beam that is projected by the scan unit 130 and then transmits through the transmission body.

In addition, the light detection unit 140 transfers the separated s-polarized beam and p-polarized beam to the signal processing unit 150.

Here, the light detection unit 140 includes a first condenser 141a, a first polarizer 142a, a first photodetector 143a, a second condenser 141b, a second polarizer 142b, and a second photodetector 143b illustrated in FIG. 1.

The first condenser 141a is arranged in a direction polarized to an optical axis of a beam projected onto a transmission body, and condenses the beam transmitting through the transmission body. This first condenser 141a may be implemented with a condensing lens.

The first polarizer 142a transmits only the s-polarized beam component therethrough among beams spatially condensed by the first condenser 141a. That is, the first polarizer 142a is arranged at a rear end of the first condenser 141a and transmits only the s-polarized beam component therethrough among the beams condensed by the first condenser 141a.

The first photodetector 143a detects the s-polarized beam transmitting through the first polarizer 142a and transfers the s-polarized beam to a first signal processing unit 151.

The second condenser 141b is arranged in a direction polarized to an optical axis of a beam projected onto a transmission body and condenses the beam transmitting the transmission body. This second condenser 141b may be implemented with a collecting lens.

Here, the second condenser 141b may also be arranged symmetrically to the first condenser 141a, but may also be arranged asymmetrically.

The second polarizer 142b transmits only the p-polarized beam component therethrough among beams spatially condensed by the second condenser 141b. That is, the second polarizer 142b is arranged at a rear end of the second condenser 141b and transmits only the p-polarized beam component therethrough among the beams condensed by the second condenser 141b.

The second photodetector 143b detects the p-polarized beam transmitting through the second polarizer 142b and transfers the p-polarized beam to a second signal processing unit 152.

Also, a structure of the light detection unit 140 in the present disclosure is not limited to FIG. 1, and may also be changed to the structure of FIG. 2 described below. This will be described in detail below.

The signal processing unit 150 processes signals of the s-polarized beam and the p-polarized beam detected separately by the light detection unit 150 to generate a hologram for a transmission body.

In the embodiment of the present disclosure, a scan beam generated by the scan beam generation unit 110 is split into two polarized beams again according to polarization, and the two split polarized beams are used as scan beams to scan a transmission body, and accordingly, compared to a case where the scan beam is not split and a transmission body is scanned as it is, twice as much sampling is possible in the same time, and a hologram for the transmission body may be generated at twice the speed.

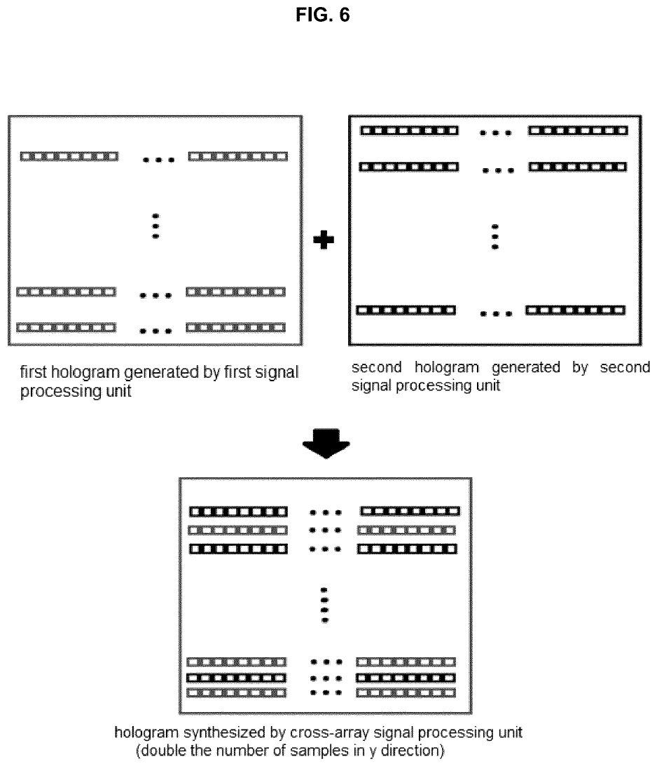

FIG. 6 is a diagram illustrating an operation of a signal processing unit according to an embodiment of the present disclosure.

Referring to FIG. 1 and FIG. 6, the signal processing unit 150 includes the first signal processing unit 151, the second signal processing unit 152, and a cross-array signal processing unit 153. A structure and operating principle of the signal processing unit 150 may be equally applied to the systems according to the second to fourth embodiments of the present disclosure (FIG. 2, FIG. 3, and FIG. 4).

The first signal processing unit 151 processes a signal of the s-polarized beam detected by the first photodetector 143a and transfers the signal to the cross-array processing unit 153, and the second signal processing unit 152 processes a signal of the p-polarized beam detected by the second photodetector 143b and transfers the signal to the cross-array processing unit 153. The operations may be performed simultaneously.

Then, as illustrated in FIG. 6, the cross-array signal processing unit 150 synthesizes a hologram signal processed by the first signal processing unit 151 and a hologram signal processed by the second signal processing unit 152 in a cross-array manner to generate a hologram for a transmission body.

According to this, a scan beam generated by the scan beam generation unit 110 is split into two beams (the s-polarized beam and the p-polarized beam) according to polarization, and the two split polarized beams are simultaneously projected onto the object (transmission body) to sample (scan) signals of two lines at one time (unit time), and accordingly, the number of samples in the y direction is doubled compared to a case of scanning without splitting the scan beam, and a hologram of the transmission body may be generated at a high speed twice as fast.

An operation of the signal processing unit 150 is described in more detail below.

In FIG. 1, the first photodetector 143a generates a current signal proportional to the intensity of the condensed light and transfers the current signal to a two-channel lock-in amplifier, and the two-channel lock-in amplifier extracts the in-phase and quadrature-phase hologram information of an object (transmission body) as an electrical signal by demodulating the current signal. The two-channel lock-in amplifier may also be implemented to convert a signal into a digital signal by using an ADC (analog to digital converter) and cause the digital signal to be arithmetically processed by a computer.

In addition, the extracted electrical signal is converted into a digital signal and transmitted to a digital computer, and the digital computer mutually synthesizes real and imaginary digital signals in a complex synthesis manner and stores the signals according to each scaning position, thereby recording the complex hologram information of an object (transmission body). In this case, the recorded hologram is referred to as a first hologram.

In FIG. 1, the second photodetector 143b generates a current signal proportional to the intensity of the condensed light and transfers the current signal to the two-channel lock-in amplifier, and the two-channel lock-in amplifier extracts the in-phase and quadrature-phase hologram information of an object (transmission body) as an electrical signal by demodulating the current signal. The two-channel lock-in amplifier may also be implemented to convert a signal into a digital signal by using an ADC (analog to digital converter) and cause the digital signal to be arithmetically processed by a computer.

In addition, the extracted electrical signal is converted into a digital signal and transmitted to a digital computer, and the digital computer mutually synthesizes real and imaginary digital signals in a complex synthesis manner and stores the signals according to each scaning position, thereby recording the complex hologram information of an object (transmission body). In this case, the recorded hologram is referred to as a second hologram.

The signal processing unit 150 may synthesize the first hologram and the second hologram in a cross-arrangement manner to implement scanning corresponding to twice the scan by a horizontal scan mirror.

Next, a polarization-splitting double-scanning holography system for a transmission body, according to a second embodiment of the present disclosure, is described with reference to FIG. 2A.

As illustrated in FIG. 2A, a polarization-splitting double-scanning holography system 200 for a transmission body, according to the second embodiment of the present disclosure, includes a scan beam generation unit 110, a scan beam splitting unit 120, a scan unit 130, a light detection unit 240, and a signal processing unit 150. Redundant descriptions of components having the same symbols as in FIG. 1 are omitted.

In the second embodiment, a basic structure of the device is the same as the structure of the first embodiment, but a configuration of the light detection unit 240 is different therefrom, and an operating principle thereof is as follows.

In the second embodiment, the light detection unit 240 includes a first light splitter 241, a second light splitter 242, a first condenser 243a, a second condenser 243b, a first photodetector 244a, and a second photodetector 244b.

The first light splitter 241 is arranged on an optical axis of light projected onto a transmission body and receives a beam transmitting through the transmission body and reflects the beam to the outside. The first beam splitter 241 may reflect some of the beams transmitting the transmission body and transfer the beams to the second beam splitter 242. The first beam splitter 241 may be implemented with a general beam splitter.

The second beam splitter 242 receives the light reflected from the first beam splitter 241, transmits a p-polarized beam component of the incident beam therethrough, and reflects a s-polarized beam component.

This second beam splitter 242 may be implemented with a polarization beam splitting unit PBS, and in this case, an s-polarized beam is reflected from the second beam splitter 242 and transferred to the first condenser 243a, and a p-polarized beam transmits therethrough and is transferred to the second condenser 243b.

The first condenser 243a condenses the s-polarized beam component reflected by the second optical splitter 242, and the second condenser 243b condenses the p-polarized beam component transmitting through the second optical splitter 242. The first and second condensers 243a and 243b may each be implemented with a condensing lens.

The first photodetector 244a detects a beam (the s-polarized beam) spatially condensed by the first condenser 243a and transfer the beam to the first signal processing unit 151 of the signal processing unit 150. Also, the second photodetector 244b detects a beam (the p-polarized beam) spatially condensed by the second condenser 243b and transfers the beam to the second signal processing unit 152 of the signal processing unit 150.

The first and second photodetectors 244a and 244b respectively generate first and second electrical signals in proportion to the intensity of the transferred light. The first photodetector 244a transfers the first electrical signal to the first signal processing unit 151, and the second photodetector 244b transfers the second electrical signal to the second signal processing unit 152.

Here, the second light splitter 242 may also be replaced with a light splitter BS instead of the polarizing light splitter PBS, and in this case, a function of the polarizing light splitter PBS may be performed by combining the light splitter BS with two polarizers. This will be described below with reference to FIG. 2B.

In FIG. 2B, the light detection unit 240 includes a first light splitter 241, a second light splitter 242, a first polarizer 245a, a second polarizer 245b, a first condenser 243a, a second condenser 243b, a first photodetector 244a, and a second photodetector 244b.

In FIG. 2B, the drawing symbols 241, 244a, and 244b perform the same functions as in FIG. 2A, and accordingly, redundant descriptions thereof are omitted.

In FIG. 2B, the second beam splitter 242 is a BS (Beam Splitter) and receives the light reflected from the first beam splitter 241, transmits some of incident beams therethrough, and reflects some of the incident beams to split the reflected beams.

The first polarizer 245a receives beams reflected from the second beam splitter 242 and transmits only a s-polarized beam component therethrough, and the second polarizer 245b receives beams transmitting through the second beam splitter and 242 transmits only a p-polarized beam component therethrough.

The first condenser 243a condenses the s-polarized beam component transmitting through the first polarizer 245a, and the second condenser 243b condenses the p-polarized beam component transmitting through the second polarizer 245b. Operations of the first and second photodetectors 244a and 244b thereafter are the same as the operations described above.

Hereinafter, a polarization-splitting double-scanning holography system for a transmission body, according to a third embodiment of the present disclosure, is described with reference to FIG. 3.

As illustrated in FIG. 3, a polarization-splitting double-scanning holography system 300 for a transmission body, according to the third embodiment of the present disclosure, includes a scan beam generation unit 110, a scan beam splitting unit 120, a scan unit 330, a light detection unit 140, and a signal processing unit 150. Redundant descriptions of components having the same symbols as the components in FIG. 1 are omitted.

In the third embodiment, a basic structure of the device is the same as the structure of the first embodiment, but a configuration of the scan unit 330 is different therefrom, and an operating principle thereof is as follows.

In FIG. 3, the scan unit 330 includes a scan mirror 331 installed at a rear end of the scan beam splitting unit 120 to control a scan beam incident from the scan beam splitting unit 120 in the horizontal direction (x direction) and transfer the scan beam to the transmission body, and a translation stage 332 that moves an object in the vertical direction (y direction) at a rear end of the transmission body, in order to control a scan position of a scan beam for a transmission body in the horizontal and vertical directions.

That is, in FIG. 3, a scan beam including two polarized beams emitted from the scan beam splitting unit 330 is incident on the scan unit 330. The beam incident on the scan unit 330 is transferred to a transmission body through the scan mirror 331. Here, the scan mirror 331 scans a transmission body in the x direction, and the translation stage 332 located at a rear end of the transmission body scans the transmission body in the y direction.

The scan mirror 331 controls the scan beam incident from the scan beam splitting unit 120 in the horizontal direction and transfers the scan beam to a transmission body. The translation stage 332 is installed at a rear end of a transmission body and directly moves the transmission body receiving the scan beam in the vertical direction, thereby enabling the y-direction scanning of the transmission body through the scan beam.

This translation stage 332 enables a target plate, on which a transmission body is placed, to move in the y-axis direction, and corresponds to a moving target plate. The translation stage 332 is physically separated from the scan mirror 331 but corresponds to a unit for controlling a scan position of a beam for a transmission body, and accordingly, the translation stage 332 is included as a component of the scan unit 330 together with the scan mirror 331.

In this way, the scan unit 330 controls the scan beam in the horizontal direction (x direction) and the vertical direction (y direction) based on a transmission body by using the scan mirror 331 and the translation stage 332.

In the third embodiment, the scan unit 330 uses a mirror scanner. The mirror scanner includes an x-scan mirror 321 that scans a transmission body in the x direction (left and right direction) with respect to an y axis. In the present disclosure, the scan unit is not limited to the mirror scanner, and a similar unit or another known scan unit may be used.

The scan unit 330 may operate by receiving a scan control signal from a scan control unit (not illustrated) of the signal processing unit 150, as in the first embodiment. The scan control unit (not illustrated) generates a scan control signal for controlling a scan position of the scan unit 330. Here, the scan control signal may include a horizontal scan signal and a vertical scan signal for respectively controlling the scan mirror 331 and the translation stage 332 in the horizontal and vertical directions.

In this case, the horizontal scan signal is a signal for sequentially moving the scan position in the horizontal direction (x-axis direction) by a preset distance unit, and has a cycle T for scan movement of a certain distance unit. The vertical scan signal, which is a signal for moving the translation stage 332 in the vertical direction, is a translation stage control signal that enables a horizontal scan operation for the next y position when a horizontal scan operation in the x-axis direction for a certain y position is completed, and a cycle thereof is greater than a cycle of the horizontal scan signal.

Also, in the structure of FIG. 3, the scan mirror 331 may be replaced with a spatial modulation scanner. In this case, the scan unit 330 may include a spatial modulation scanner 331 and a translation stage 332. Hereinafter, for the sake of convenience of description, a symbol 331 is assigned to the spatial modulation scanner.

In this case, a beam incident on the scan unit 330 is transferred to a transmission body via a spatial modulation scanner 331. Here, the spatial modulation scanner 331 scans a transmission body in the x direction, and the translation stage 332 located at a rear end of the transmission body scans the transmission body in the y direction.

That is, the spatial modulation scanner 331 controls the scan beam incident from the scan beam splitting unit 120 in the horizontal direction and transfers the scan beam to a transmission body, and the translation stage 132 directly moves a corresponding transmission body that receives the scan beam at the rear end of the transmission body in the vertical direction, thereby enabling the y-direction scanning of the transmission body through the scan beam.

In this way, the scan unit 330 may also control the scan beam in the horizontal direction (x direction) and the vertical direction (y direction) based on a transmission body by using the spatial modulation scanner 331 and the translation stage 332.

In this case, the spatial modulation scanner operates to scan a beam in a specific direction by modulating a spatial distribution of an incident beam.

The spatial modulation scanner may be implemented with an SLM (spatial light modulator), a DMD (digital micromirror device), an acousto-optic deflector, or so on. Accordingly, the spatial modulation scanner is configured to include one type of spatial modulation scanner selected from among an SLM, a DMD, and an acousto-optic deflector.

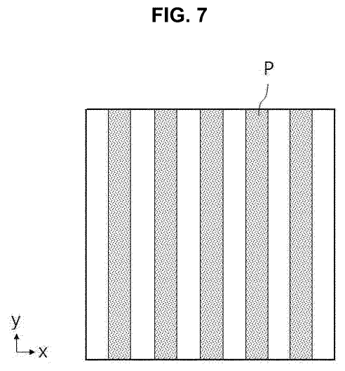

FIG. 7 is a diagram illustrating an operating principle of a spatial modulation scanner. The spatial modulation scanner is a component that may replace the scan mirror 131 of the scan unit 330 of FIG. 3, and corresponds to a horizontal spatial modulation scanner that scans a transmission body in the x direction. FIG. 7 illustrates a principle of the horizontal spatial modulation scanner.

As illustrated in FIG. 7, the spatial modulation scanner controls a scan beam in the horizontal direction by sequentially changing a spacing of a grating pattern P over time according to an input of a scan control signal by a scan control unit (not illustrated).

That is, the spacing of the grating pattern formed in the horizontal spatial modulation scanner by an electrical signal is adjusted over time, allowing an incident beam to move in the x direction. In general, the narrower the spacing between patterns, the more the light is bent at a greater angle.

Therefore, the horizontal spatial modulation scanner may move a scan beam in the horizontal direction by adjusting a size of the spacing between the grating patterns P formed along the horizontal direction according to the scan control signal. In this way, the spatial modulation scanner electrically control a direction of an incident beam.

In this case, the scan unit 330 also operates by receiving a scan control signal from a scan control unit (not illustrated) of the signal processing unit 150. Here, the scan control signal for the spatial modulation scanner 331 may include a signal for sequentially changing a size of the spacing between the grating patterns over time. In addition, the scan control signal for the translation stage 332 may include a signal for moving the translation stage 332 in the vertical direction over time.

In addition, the scan control signal may include a horizontal scan signal and a vertical scan signal for respectively controlling a scan beam in the horizontal direction and the vertical direction.

The horizontal scan signal for controlling a scan beam incident on the spatial modulation scanner 331 in the horizontal direction is a signal for sequentially moving a scan position in the horizontal direction (x-axis direction) by a preset distance unit, and has a cycle T for a scan movement of a certain distance unit. The vertical scan signal, which is a signal for moving the translation stage 332 in the vertical direction, is a translation stage control signal that enables a horizontal scan operation for a next y position when a horizontal scan operation in the x-axis direction for a certain y position is completed, and a cycle thereof is greater than a cycle of the horizontal scan signal.

Here, both the horizontal scan mirror 131 and the vertical scan mirror 132 of FIG. 1 may be replaced with a spatial modulation scanner, and in this case, the scan unit 120 may be implemented with an x-y scanner including a horizontal spatial modulation scanner (x-spatial modulation scanner) that scans a target in the x direction and a vertical spatial modulation scanner (y-spatial modulation scanner) that scans the target in the y direction.

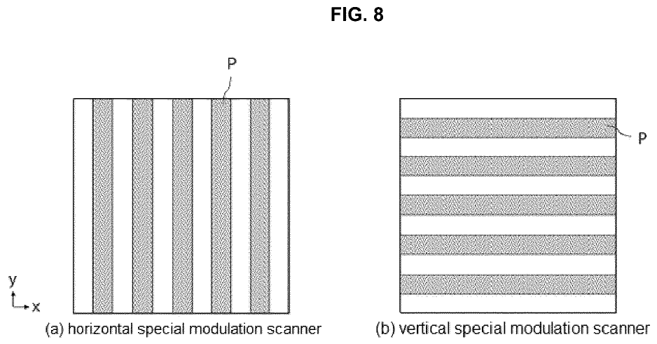

FIG. 8 is a diagram illustrating operating principles of horizontal and vertical spatial modulation scanners. As illustrated in FIG. 8, the vertical or horizontal spatial modulation scanner controls a scan beam in the vertical or horizontal direction while a spacing between grating patterns P is sequentially changed over time according to an input of the scan control signal by a scan control unit (not illustrated).

That is, the spacing between grating patterns formed in the spatial modulation scanner by an electrical signal may be adjusted over time, allowing an incident beam to move in the x direction. In general, the narrower the spacing between patterns, the more the light is bent at a greater angle.

For example, the horizontal spatial modulation scanner may move a scan beam in the horizontal direction by adjusting the size of a spacing between the grating patterns P formed in the horizontal direction according to the scan control signal. The vertical spatial modulation scanner may move the scan beam in the vertical direction by adjusting the size of the spacing between the grating patterns P formed in the vertical direction according to the scan control signal.

In this way, the spatial modulation scanner electrically controls the direction of an incident beam.

Hereinafter, a polarization-splitting double-scanning holography system for a transmission body, according to a fourth embodiment of the present disclosure, is described with reference to FIG. 4A.

As illustrated in FIG. 4A, a polarization-splitting double-scanning holography system 400 for a transmission body, according to the fourth embodiment of the present disclosure, includes a scan beam generation unit 110, a scan beam splitting unit 120, a scan unit 330, a light detection unit 240, and a signal processing unit 150. Redundant descriptions of components having the same symbols as in FIG. 1 are omitted.

In the fourth embodiment, a basic structure of the device is the same as the structure of the first embodiment, but configurations of the scan unit 330 and the light detection unit 240 are different therefrom. Here, an operation of the scan unit 330 is described in detail above with reference to FIG. 3, and an operation of the light detection unit 240 is described in detail above with reference to FIG. 2A, and accordingly, redundant descriptions thereof are omitted.

Meanwhile, the first to fourth embodiments of the present disclosure may each further include a circular polarization converter. An operation of the circular polarization converter may be performed through configurations of λ/4 wave plates WP (WP1 and WP2) inserted respectively as dotted lines in FIG. 1 and FIG. 2A. In FIG. 3 and FIG. 4A, the circular polarization converters illustrated in FIG. 1 and FIG. 2A may also be applied.

Representatively, for example, FIG. 1 includes a first λ/4 wave plate WP1 and a second λ/4 wave plate WP2.

In this case, the first λ/4 wavelength plate WP1 is installed between the scan unit 130 and a transmission body to convert a scan beam into a circularly polarized beam and projects the beam onto the transmission body. The second λ/4 wavelength plate WP2 is installed between a transmission body and the light detection unit 140 to convert the circularly polarized beam back into a linearly polarized beam and provides the beam to the light detection unit 140. Specifically, the second λ/4 wavelength plate WP2 is individually installed between a transmission body and a first condensing unit 141a and between the transmission body and a second condensing unit 141b.

As in the embodiment of the present disclosure, a method of splitting a scan beam into two beams according to polarization and individually detecting the beam corresponding to the polarization may cause a difference in polarization between a first hologram and a second hologram when reflection or transmittance of a transmission body depends on polarization. In order to remove a polarization difference, a wave plate is provided between the scan unit 130 and a target object (transmission body) to convert a scan beam into a circularly polarized beam and project the beam onto the target object, and a wave plate is provided between a target object (transmission body) and the condenser 141 to convert circular polarization back into a linear polarization, thereby enabling first and second holograms to be recorded regardless of the polarization dependency of the target object.

In addition, in FIG. 2A, the first λ/4 wave plate WP1 may be installed on a path between the scan unit 130 and a transmission body, more specifically, between the scan unit 130 and the first light splitter 241, and the second λ/4 wave plate WP2 may be installed between a transmission body and the light detection unit 240, more specifically, between the first light splitter 241 and the second light splitter 242 on a corresponding path. Also, installation positions of the wave plates may be modified in various ways.

According to the present disclosure, a hologram of a transmission body that is a transmissive object may be obtained at an ultra-high speed faster than a scan speed of a scan mirror.

Although the present disclosure is described with reference to the embodiments illustrated in the drawings, the embodiments are merely examples, and those skilled in the art will understand that various modifications and equivalent other embodiments may be derived therefrom. Therefore, the true technical protection scope of the present disclosure should be determined by the technical idea of the appended patent claims.

1. A polarization-splitting double-scanning holography system for a transmission body, the polarization-splitting double-scanning holography system comprising:
a scan beam generating unit configured to modulate a phase of a first beam split from a light source and convert the first beam into a first curvature beam through a first beam curvature generating unit, convert a second beam into a second curvature beam through a second beam curvature generating unit, and generate a scan beam by interfering the first curvature beam and the second curvature beam;
a scan beam splitting unit configured to split the scan beam into an s-polarized beam and a p-polarized beam and emit the s-polarized beam and the p-polarized beam parallel to each other;
a scan unit configured to receive the scan beam composed of the s-polarized beam and the p-polarized beam emitted parallel to each other from the scan beam splitting unit, project the scan beam onto a transmission body, and transfers the scan beam to the transmission body by controlling a scanning position of the scan beam for the transmission body in a horizontal direction and a vertical direction;
a light detection unit configured to detect separately the s-polarized beam and the p-polarized beam from a beam transmitting through the transmission body; and
a signal processing unit configured to process signals of the separately detected s-polarized beam and p-polarized beam to generate a hologram of the transmission body.

2. The polarization-splitting double-scanning holography system of claim 1, wherein the light detection unit comprises:
a first condenser arranged in a direction polarized to an optical axis of a beam projected onto the transmission body and configured to condense a beam transmitting through the transmission body;
a first polarizer configured to cause only an s-polarized beam component of a beam spatially condensed through the first condenser to transmit through the first polarizer;
a first photodetector configured to detect an s-polarized beam transmitting through the first polarizer;
a second condenser arranged in a direction polarized to the optical axis of the beam projected onto the transmission body, arranged at a different position from the first condenser, and configured to condense a beam transmitting through the transmission body;
a second polarizer configured to cause only a p-polarized beam component of a beam spatially condensed through the second condenser to transmit through the second polarizer; and
a second photodetector configured to detect a p-polarized beam transmitting through the second polarizer.

3. The polarization-splitting double-scanning holography system of claim 1, wherein the light detection unit comprises:
a first light splitter arranged on an optical axis of light projected onto the transmission body, receive a beam transmitting through the transmission body, and reflect the beam to an external unit;
a second light splitter configured to receives light reflected from the first light splitter, cause a p-polarized beam component to transmit through the second light splitter, and reflect a s-polarized beam component of an incident beam;
a first condenser configured to condense the s-polarized beam component reflected from the second light splitter;
a second condenser configured to condense the p-polarized beam component transmitting through the second light splitter;
a first photodetector configured to detect a beam spatially condensed through the first condenser; and
a second photodetector configured to detect a beam spatially condensed through the second condenser.

4. The polarization-splitting double-scanning holography system of claim 1, wherein the light detection unit comprises:
a first light splitter arranged on an optical axis of light projected onto the transmission body, receive a beam transmitting through the transmission body, and reflect the beam to an external unit;
a second light splitter configured to receive light reflected from the first light splitter, cause some of incident beams to transmit through the second light splitter, and reflect others of the incident beams;
a first polarizer configured to receive a beam reflected from the second light splitter and cause only an s-polarized beam component to transmit through the first polarizer;
a second polarizer configured to receive a beam transmitting through the second light splitter and cause only a p-polarized beam component to transmit through the second polarizer;
a first condenser configured to condense the s-polarized beam component transmitting through the first polarizer;
a second condenser configured to condense the p-polarized beam component transmitting through the second polarizer;
a first photodetector configured to detect a beam spatially condensed through the first condenser; and
a second photodetector configured to detect a beam spatially condensed through the second condenser.

5. The polarization-splitting double-scanning holography system according to claim 2, wherein the signal processing unit comprises:
a first signal processing unit configured to process a signal of the s-polarized beam detected by the first photodetector;
a second signal processing unit configured to process a signal of the p-polarized beam detected by the second photodetector; and
a cross-array signal processing unit configured to synthesize a hologram signal processed by the first signal processing unit and another hologram signal processed by the second signal processing unit in a cross-array manner to generate a hologram of the transmission body.

6. The polarization-splitting double-scanning holography system of claim 1, wherein the scan beam splitting unit includes a beam displacer made of an anisotropic optical material, and configured to split a scan beam incident through a first surface into an s-polarized beam and a p-polarized beam orthogonal to each other and emit the s-polarized beam and the p-polarized beam side by side through a second surface.

7. The polarization-splitting double-scanning holography system of claim 6, wherein the scan beam splitting unit further includes an optical path difference correction unit installed on a path of the p-polarized beam, which is shorter among paths of the s-polarized beam and the p-polarized beam emitted through the second surface, implemented with the same material as the beam displacer, and configured to compensate for a difference in optical path length between the s-polarized beam and the p-polarized beam which are emitted.

8. The polarization-splitting double-scanning holography system of claim 1, wherein the scan beam splitting unit includes a polarization prism made of a combination of two triangular prisms whose crystal axes are perpendicular to each other and made of different materials, and configured to split a scan beam incident through a first surface into a first polarized beam that travels parallel to the scan beam at a boundary between the two triangular prisms and a second polarized beam that travels at a set angle to the scan beam and emit the first polarized beam and the second polarized beam through a second surface, and
when the first polarized beam is the s-polarized beam, the second polarized beam is the p-polarized beam, and when the first polarized beam is the p-polarized beam, the second polarized beam is the s-polarized beam.

9. The polarization-splitting double-scanning holography system of claim 8, wherein the scan beam splitting unit further comprises:
a displacement adjustment unit configured to adjust a travel direction of travel of the second polarized beam to be parallel to the scan beam through a first mirror and a second mirror that are sequentially installed on a path of the second polarized beam emitted through a second surface and change a beam path; and
an optical path difference correction unit installed on a path of the first polarized beam, which is shorter among paths of the first polarized beam and the second polarized beam emitted through the second surface, and configured to compensate for a difference in optical path length between the first polarized beam and the second polarized beam that are emitted.

10. The polarization-splitting double-scanning holography system of claim 9, wherein the optical path difference correction unit comprises:
third to sixth mirrors sequentially installed on the path of the first polarized beam emitted through the second surface to change a beam path; and
a mirror movement unit configured to move fourth and fifth mirrors separated from the third and sixth mirrors as a group and compensate for the difference in the optical path length.

11. The polarization-splitting double-scanning holography system of claim 8, wherein the polarization prism has a Rochon prism structure or a Senarmont prism structure.

12. The polarization-splitting double-scanning holography system of claim 8, wherein the polarization prism is installed in a state of being rotated by a set angle based on a center of a boundary surface, and
the set angle is θ/2 which is half of an angular difference θ between propagation directions of the first polarized beam and the second polarized beam separately emitted from the center of the boundary surface.

13. The polarization-splitting double-scanning holography system of claim 12, wherein the scan beam splitting unit further includes a displacement control unit including first and second mirrors that are sequentially installed on a path of the second polarized beam emitted through the second surface to change a beam path, and third and fourth mirrors that are sequentially installed on a path of the first polarized beam emitted through the second surface to change a beam path and are installed symmetrically to the first and second mirrors, and
a propagation direction of the second polarized beam transmitting through the second mirror and a propagation direction of the first polarized beam transmitting through the fourth mirror are adjusted to be parallel by the displacement control unit.

14. The polarization-splitting double-scanning holography system of claim 1, wherein the scan beam splitting unit includes a polarization prism that has a Wollaston prism structure, is formed by a combination of two triangular prisms having crystal axes perpendicular to each other and made of different materials, splits a scan beam incident through a first surface into an s-polarized beam and a p-polarized beam that travel symmetrically to a direction of the scan beam at a set angle at a boundary between two triangular prisms, and emits the s-polarized beam and the p-polarized beam through a second surface.

15. The polarization-splitting double-scanning holography system of claim 14, wherein the scan beam splitting unit further includes a displacement control unit including first and second mirrors that are sequentially installed on a path of the p-polarized beam emitted through the second surface to change a beam path, and third and fourth mirrors that are sequentially installed on a path of the s-polarized beam emitted through the second surface to change a beam path and are installed symmetrically to the first and second mirrors, and
a propagation direction of the p-polarized beam transmitting through the second mirror and a propagation direction of the s-polarized beam transmitting through the fourth mirror are adjusted to be parallel by the displacement control unit.

16. The polarization-splitting double-scanning holography system of claim 1, wherein the scan beam splitting unit comprises:
a first polarization beam splitting unit configured to reflect an s-polarized beam component of an incident scan beam and transmit a p-polarized beam component through the first polarization beam splitting unit;
first and second mirrors sequentially installed on a path of the s-polarized beam reflected by the first polarization beam splitting unit to change a beam path by 90 degrees;
third to sixth mirrors sequentially installed on a path of the p-polarized beam transmitting through the first polarization beam splitting unit to change a beam path by 90 degrees; and
a second polarization beam splitter configured to receive an s-polarized beam transmitting through the second mirror and a p-polarized beam transmitting through the sixth mirror respectively through a first surface and a second surface, and emit an s-polarized beam reflected after being incident on the first surface and a p-polarized beam transmitted after being incident on the second surface in a parallel direction through a third surface.

17. The polarization-splitting double-scanning holography system of claim 1, wherein the scan unit includes a horizontal scan mirror and a vertical scan mirror to control a scan position of the scan beam for a transmission body, and controls the incident scan beam in the horizontal direction and the vertical direction and transfers the scan beam to the transmission body.

18. The polarization-splitting double-scanning holography system of claim 1, wherein the scan unit includes a scan mirror for controlling the scan beam incident from the scan beam splitter in the horizontal direction and transfers the scan beam to a transmission body and a translation stage for moving the transmission body in the vertical direction at a rear end of the transmission body, in order to control a scan position of the scan beam for the transmission body in the horizontal direction and the vertical direction.

19. The polarization-splitting double-scanning holography system of claim 1, wherein the scan unit includes a spatial modulation scanner for controlling the scan beam incident from the scan beam splitter in the horizontal direction and transfers the scan beam to a transmission body, and a translation stage for moving the transmission body in the vertical direction at a rear end of the transmission body, in order to control a scan position of the scan beam for the transmission body in the horizontal direction and the vertical direction.

20. The polarization-splitting double-scanning holography system of claim 1, wherein the scan unit includes a vertical scanner and a horizontal scanner for controlling a scan position of the scan beam for a transmission body in the horizontal direction and the vertical direction, a horizontal spatial modulation scanner for controlling the scan beam incident from the scan beam splitting unit in the horizontal direction and transfers the scan beam to the transmission body, and a vertical spatial modulation scanner for controlling the scan beam in the vertical direction and transfers the scan beam to the transmission body.

21. The polarization-splitting double-scanning holography system according to claim 3, wherein the signal processing unit comprises:
a first signal processing unit configured to process a signal of the s-polarized beam detected by the first photodetector;
a second signal processing unit configured to process a signal of the p-polarized beam detected by the second photodetector; and
a cross-array signal processing unit configured to synthesize a hologram signal processed by the first signal processing unit and another hologram signal processed by the second signal processing unit in a cross-array manner to generate a hologram of the transmission body.

22. The polarization-splitting double-scanning holography system according to claim 4, wherein the signal processing unit comprises:
a first signal processing unit configured to process a signal of the s-polarized beam detected by the first photodetector;
a second signal processing unit configured to process a signal of the p-polarized beam detected by the second photodetector; and
a cross-array signal processing unit configured to synthesize a hologram signal processed by the first signal processing unit and another hologram signal processed by the second signal processing unit in a cross-array manner to generate a hologram of the transmission body.
